(19) United States
(12) Patent Application Publication
(10) Pub. No.: US 2002/0025407 A1
(43) Pub. Date: Feb. 28, 2002

(54) Photographic paper for printers

(76) Inventors: Joao Alfredo Monteiro Luna, Rio de Janeiro (BR); Arides Garcia De Luna, Rio de Janeiro (BR)

Correspondence Address: John B. Hardaway, III, NEXSEN PRUET JABOBS & POLLARD, LLC, P.O. Box 10107, Greenville, SC, 29603, US

(21) Appl. No.: 09/934,730

(22) Filed: Aug. 22, 2001

(30) Foreign Application Priority Data
Aug. 23, 2000 (BR) 0003756-7

(51) Int. Cl. B32B 3/00; B32B 3/10

(52) U.S. Cl. 428/137; 428/195

(57) ABSTRACT

The object of the present patent concerns a process for obtaining photographs by means of printers, where the final products, the photographs, present a perfect finishing on cuts, with total printing of desired field, however without the undesirable white marks.

The process consists in producing a laminated made up of photographic paper (5) and a liner (6) formed by low weight paper (7) and a low adherence adhesive (8). Laminated is coiled to be passed later by a cut equipment which shall be regulated to produce partial cuts (2) to the desirable sizes of the photos, type: A6, 3×4 cm, etc., these cuts only reaching the photographic paper (5) without reaching liner (6) and then equipment will produce total cuts which will detach sheets from laminated and could contain only one photographic field (3) or several photographic fields (9), etc.

After the printing of the photographs, the margins (4) are easily detached, getting off with all the liner (6), which did not receive the cut (2), what gives to the photographs a perfect finishing on their borders (1).

The present invention refers to a process for obtaining photographs by printers, where the final product, the photographs, in any size, comprehend all determined space, without undesirable white marks and with two ends perfectly straight.

Photographic papers for printing in inkjet printers, thermal transference, wax jet, etc., existing in the marked have A4 format (210×297 cm), letter format (216×179 cm), i.e. in flat sheets. There is also the A6 format (102×152 cm) that presents margins beyond the determined size and that can change from one supplier to another; these margins are disposable by means of micro-serrated.

Margins without printing of four sizes of the paper are required due to the limitations of the printer types, being their objectives to allow the printing of the photo to take completely the useful area of the A4 paper (210×297 cm) without letting white marks the are presented as a white frame around the photo.

Paper existing on the market allows that those margins are removed after printing, detaching them, as they as micro-serrated. Thus, the printed photograph gets the aspect similar to a photo revealed in the four-side system, but, when it presents only in its basis, as some manufacturers do, the photograph present white margins on the three remaining borders. The big disadvantage of this method is that micro-serrated let paper boards with an irregular finishing, which is wavy, serrated, devaluating final finishing of the photograph and taking off the characteristic of its main purpose, i.e., to be identical to a traditional revelation photograph.

The present invention not only overcomes the existing difficulties, but also add undeniable advantages when producing photographic paper in the desired sizes more the margins, that we can call safety margins, for a good presentation of the photographs, where the margins are easily removed after printing, without micro-serrated that add an undesirable aspect, in addition to present risks for tearing the photographs if they are not well made. The margins, in the present invention come completely and uninterruptedly cut from the sheet body, and the photo gets a perfect finishing on its boarder, as the photographs revealed by the traditional system.

The process of the present invention consists in producing a laminated constituted of photograph paper proper, which is a laminated with a liner, that is a low weight containing a low adherence adherent adhesive, i.e., of low adhering capacity. The laminated so produced is coiled, and is them ready to be inserted in the cutting equipment. This equipment is regulated in accordance with the requirement of producing cuts in the total size of the sheet (in the case of magnified photographs) or at an other sizes, as, for instance, 3×4 cm; 10×15 cm, etc., always intending to use as much space as possible on the sheet.

The laminated of the present invention is introduced into the cutting equipment that produces in the first place a half-cut (low weight paper+low adherence adhesive), thereafter producing a second cut, this one reaching the whole laminated in the total size of A4, A6 sheet, etc., more lateral margins, upper and lower margins. So, you have sheets with defined sizes and with photograph sizes, among these, also pre-defined sizes.

In the present invention the removal of margins is made, after printing, very easily, by the two great advantages presented, that are the fact of the cut be total and uninterrupted and not micro-serrated, thus not presenting the tears due to inefficiency of the micro-serrated, in addition to the adhesive presenting low adherence, first adhered to the liner paper. Thus, final product has an excellent finishing and without undesirable white marks.

Drawings presented show the real invention with no limiting characteristic, only as an example of the description, emphasizing its characteristics and showing the great advantages of the invention.

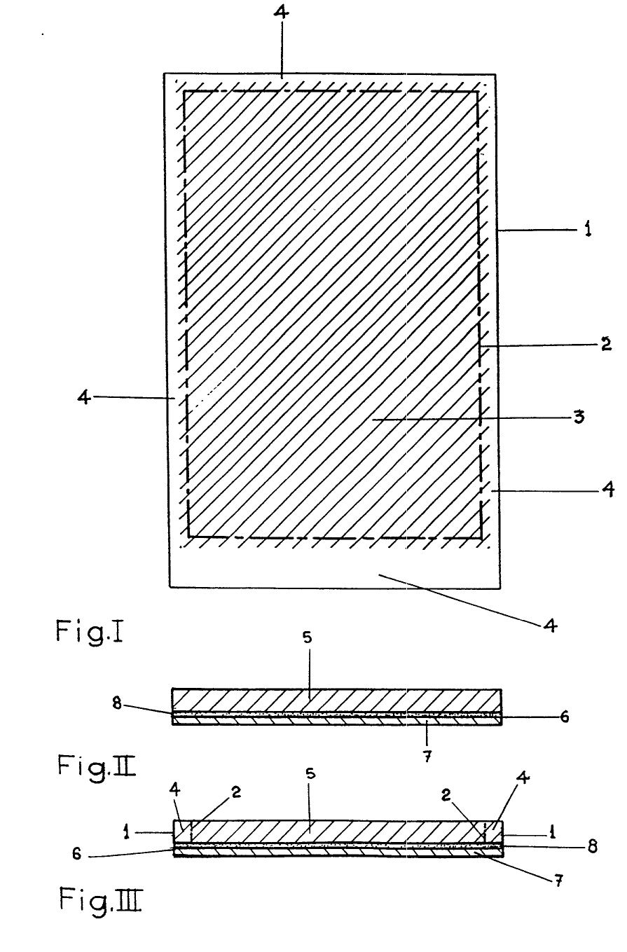

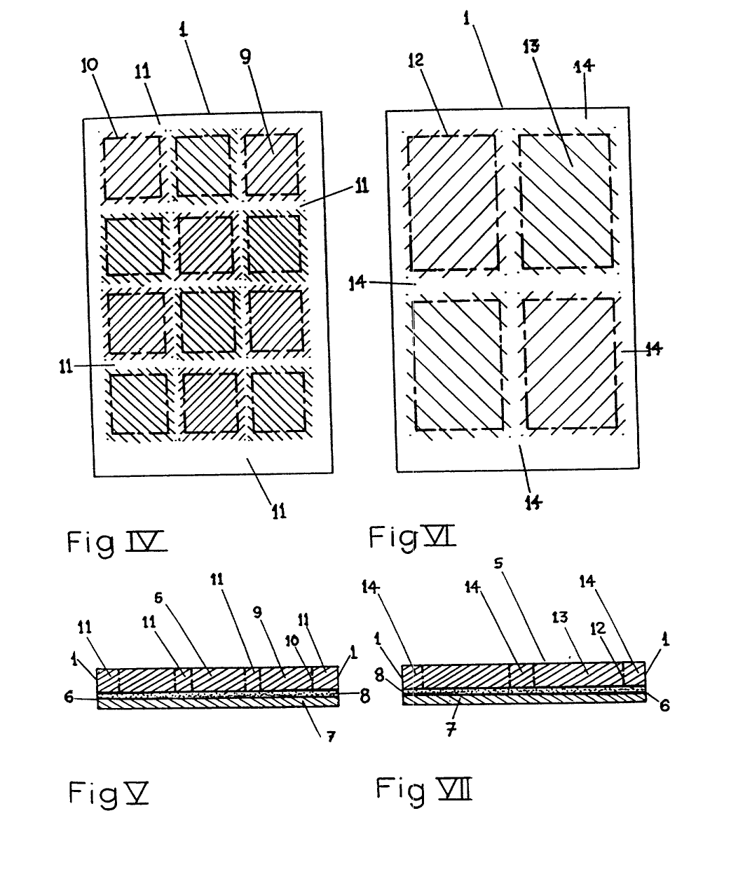

FIG. 1 shows an upper view of a sheet already detached from laminated where (1) represents the external borders of the sheet, reached with the second cut made by equipment on laminated; (2) represents the total cut made on photographic paper, without reaching the “liner”; (3) represents the extension of the application of the photo on the photographic paper, being visible that the later surpasses the cut (2), assuring the nonexistence of the white margin within the field desired for photo; (4) it is the margin to be detached after the impression made on the photograph field

FIG. II shows a front horizontal section of laminated where (5) is the photographic paper; (6) is the liner formed by the low weight (7) and by the low adherence adhesive (8), the way it is coiled after its elaboration.

FIG. III shows a front horizontal section of the laminated, where one can perceive the photographic paper (5) cut on its two sides by the cut (2) and the liner (6), not being affected by these cuts (2); (1) is the cut of detachment for laminate sheet; (4) the margins to be detached; (7) the low weight paper and (8) the low adherence adhesive.

FIG. IV shows an upper view of a sheet already detached from laminate, where (1) are the borders reached by the second cut of the equipment; (10) is the partial cut only reaching photographic paper and forming several fields (9) for 3×4 cm photographs; (11) are the margins to be detached from the photos and that have white portion and printed portions, which is the guarantee surplus of the photograph.

FIG. V shows a horizontal front section of the sheet containing 3×4 cm photographs where (5) is the photographic paper; (6) is the liner, formed by the low weight paper (7) and of the low adherence adhesive (8); (9) are the fields for photographs; (11) the margins to be detached; (10) partial cuts that reach only the photographic paper (5) and (1) the cut of detachment of laminate sheet.

FIG. IV shows a sheet already detached by the laminate side, where (1) is the detachment cut, (12) are partial cuts that reach only photographic paper, limiting fields (13) for 18×15 cm photographs, and (14) are the margins to be detached after printing and that include white parts and parts with printing surplus of the photographs.

FIG. VII shows a horizontal front view of the sheet containing 18×15 cm photographs where (1) is the detachment cut of laminate sheet; (5) is the photographic paper; (6) is the liner formed by low weight paper (7) and by the low adherence adhesive (8); (13) is the field for 18×15 cm photographs; (12) partial cuts for detachment of photographs and that do not reach the liner (6), which is formed by the low weight paper (7) and of the low adherence adhesive (8); (14) are the margins to be detached after printing.

It is therefore evidenced the ease with which the object of the present invention can diversify the cuts and produce as much photograph sizes as it could be desired, with accuracy of the cuts, total convenience, at the detachment of the margins and reaching their perfect final finishing.

1. Photographic paper for printers, characterized by the fact of being produced a laminate constituted of photographic paper (5) with a liner (6) formed by low weight paper (7) and a low adherence adhesive (8), where is produced in one equipment partial cuts (2) for detachment of photographs and total cuts that produce edges (1) for detachments of the laminate sheets, being the photograph margins (4) detached from the sheet after printing in a determined field (3).

2. Photographic paper for printers in accordance with claim 1, characterized by the fact of partial cuts (2) being made in accordance and with the size determined for the photograph.

3. Photographic paper for printers in accordance with claim 1, characterized by containing the sheet detached from the laminate for as much photographic fields (9) as can be included therein, depending on the size of the determined field.

4. Photographic paper for printers in accordance with claim 1, characterized by the fact of these cuts being partial uninterrupted and reach only the photographic paper (5), without reaching the liner (6).
